(19) United States
(12) Patent Application Publication
(10) Pub. No.: US 2002/0081143 A1
(43) Pub. Date: Jun. 27, 2002

(54) Note creating and retaining calendar

(75) Inventor: Yoon S. Whang, Newport Beach, CA (US)

Correspondence Address: DiPINTO & SHIMOKAJI, P.C., 1301 Dove Street Suite 480, Newport Beach, CA, 92660, US

(73) Assignee: Avalanche Publishing, Inc.,, Huntington Beach, CA (US)

(21) Appl. No.: 09/745,765

(22) Filed: Dec. 22, 2000

(51) Int. Cl. B42F 3/00; B42F 13/02; B42F 3/06; B42F 13/04

(52) U.S. Cl. 402/57

(57) ABSTRACT

A note creating and retention calendar comprises a first cover and a second cover interfacing the first cover. A plurality of recording elements are disposed between the first and second covers and are positionable in a plurality of single views to a user. At least one of the single views has a current time period section of at least one month, a prior time period section of at least two months, and a subsequent time period section of at least two months. The sections for creating and retaining first notes. A non-time sensitive section is adjacent at least one of the single views for creating and retaining second notes.

### BACKGROUND OF THE INVENTION

1. Field of the Invention

The present invention generally relates to apparatus for creating and retaining writings and, more particularly, to apparatus for creating and retaining written notes such that a user has simultaneous access to date sensitive notes for a period of several months.

2. Description of Related Art

Apparatus and methods have been employed in the past to enable one to create and retain written notes that are date sensitive, i.e., contain subject matter that is correlated to a date. In a most basic fashion, people have simply written notes on blank pieces of paper and left them stacked on a desk, pinned to a board, or magnetically attached to a kitchen refrigerator. With the advent of items similar to Post-It-Notes manufactured 3M, people continue to post notes onto their desks, computer monitors, and other surfaces. However, creating and retaining notes in the above fashion often leaves the notes disorganized and not all in simultaneous, easy view.

Computer calendars have given persons greater ease in creating and maintaining notes that are date sensitive. Such calendars typically allow one to enter notes, such as a meeting reminder, for a given day. They also commonly allow one to move the notes from one day to another. However, the time period over which the notes span in a single view is typically limited to about 30 days. In other words, while the dates of other months may be shown on the single view, the notes created outside of the 30 day span are not viewable and/or subject to modification. Also, a great number of persons are uncomfortable in using computers and, thus, computer calendars are of limited benefit.

Paper based calendars often provide a means of creating and retaining notes in any given day, as well as allow one to view simultaneously a month or a week of notes. These calendars may also allow one in a single view to see the days of months outside the month containing notes. Therefore, they too are limited in that one cannot view notes in a single view outside of the 30 days. They also do not provide supplemental means for creating and retaining notes that may not be date sensitive. Further, they may not provide sufficient means to display multiple months while enabling the creation and retention of notes.

As can be seen, there is a need for an apparatus that allows for date sensitive note creation and retention. Also needed is an apparatus that provides supplemental means for note creation and retention that may not be date sensitive. A note creating and retention apparatus in the form of a calendar is needed, including one that provides in a single view access to notes that span more than 30 days, including up to about 5 months. A note creating and retention calendar is also needed that may hang from a wall, for example, while displaying in a single view up to 5 months of notes and providing access to days outside of such 5 months. A calendar is needed that is simple in design yet provides note creating and retaining means.

### SUMMARY OF THE INVENTION

In one general aspect of the present invention, an apparatus for note creation and retention comprises a first cover and a second cover interfacing the first cover. A recording element is disposed between the first and second covers and positionable in a single view to a user. The single view has a current time period section, a prior time period section, and a subsequent time period section for creating and retaining first notes.

In a more specific aspect of the present invention, a note creating and retention calendar comprises a first cover and a second cover interfacing the first cover. A plurality of recording elements are disposed between the first and second covers and are positionable in a plurality of single views to a user. At least one of the single views has a current time period section of at least one month, a prior time period section of at least two months, and a subsequent time period section of at least two months. The sections are for creating and retaining first notes. A non-time sensitive section is adjacent at least one of the single views for creating and retaining second notes.

These and other features, aspects and advantages of the present invention will become better understood with reference to the following drawings, description, and claims.

### BRIEF DESCRIPTION OF THE DRAWINGS

FIG. 1 is a perspective view of a calendar in a closed position according to an embodiment of the present invention;

FIG. 2 is a plan view of a rear side of the calendar shown in FIG. 1;

FIG. 3 is a top view of the calendar shown in FIG. 1;

FIG. 4 is a side view of a side of the calendar shown in FIG. 1;

FIG. 5 is a perspective view of the calendar in an open position according to an embodiment of the present invention; and

FIG. 6 is a plan view of a portion of the calendar in another embodiment of the present invention.

### DESCRIPTION OF THE PREFERRED EMBODIMENTS

The present invention is described below in the context of a “calendar.” The reference to “calendar” is intended to generally refer to sheets of paper that allow writing on them and/or have pre-printed writing on them for the days of the year. Additionally, while the calendar of the present invention is shown in the drawings hereto with a rectangular configuration, other configurations can be used to accommodate to the shape of the paper being used. Thus, if the paper is octagon in shape, as an example, the overall shape of the calendar, including any of its covers, may be octagonal.

Likewise, the calendar of the present invention may be sized according to the needs of user and environment. For example, if it is be hung on a wall, the calendar may be dimensioned at about 12 inches long×12 inches wide×⅜ inch thick when in a closed position.

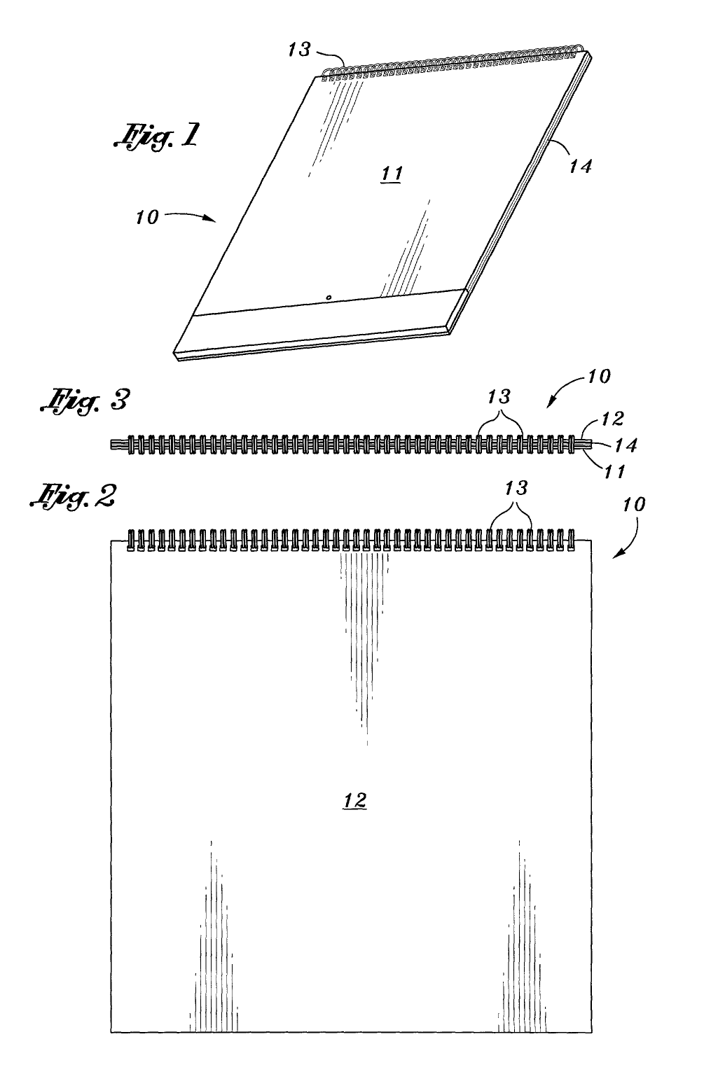

In FIG. 1, a note creating and retaining apparatus or calendar 10 according to one embodiment of the present invention is shown. The calendar 10 may include a first or front cover 11 that interfaces or is juxtaposed to a second or back cover 12 (FIG. 2). The first cover 11 has a substantially planar configuration. It may be constructed of various materials such as paper or an impact resistant material like plastic or metal so that the first cover 11 is prevented from bending or otherwise changing its shape to such an extent that paper 14 within the calendar 10 is protected from damage. Likewise, the second cover 12 has a substantially planar configuration. It too may be made of paper or an impact resistant material. However, the back cover 12 may be made thicker than the front cover 11 so as to provide overall structural support for the calendar 10. As an example, the back cover 12 may be about 2 mm thick.

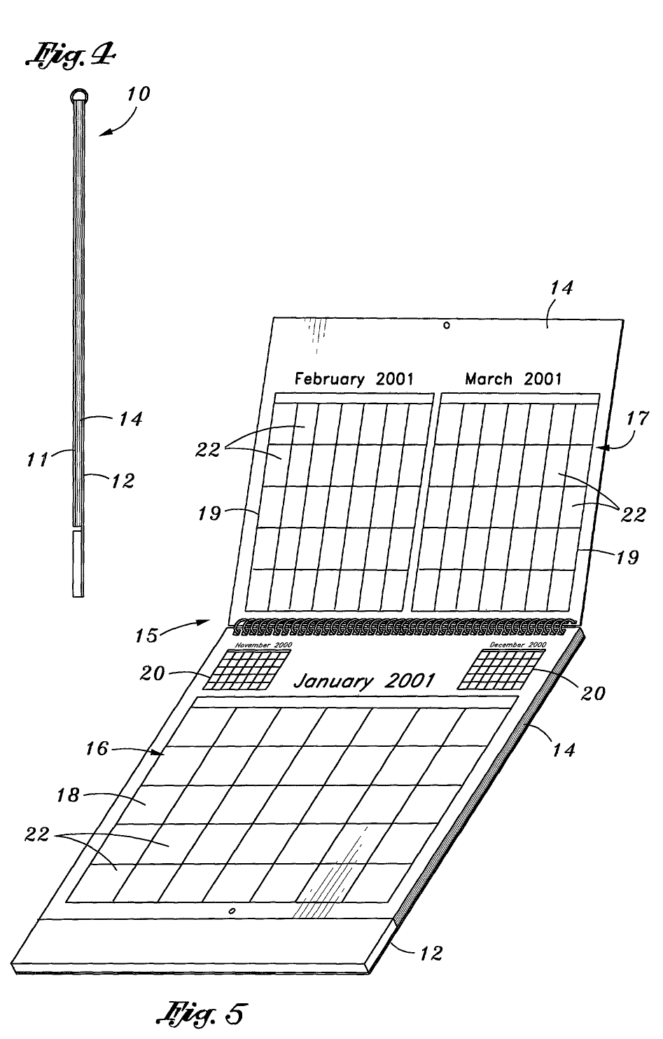

A binding 13 binds the first cover 11 to the second cover 12 at one of their opposed edges (FIGS. 3 and 4). The binding 13 may also bind or sandwich between the covers 11, 12 a plurality of sheets of paper or recording elements 14 at the same one edge. In this embodiment, and while other bindings can be used, the binding comprises a spiral wire that extends through a plurality of apertures in the first and second covers 11, 12, as well as the paper 14.

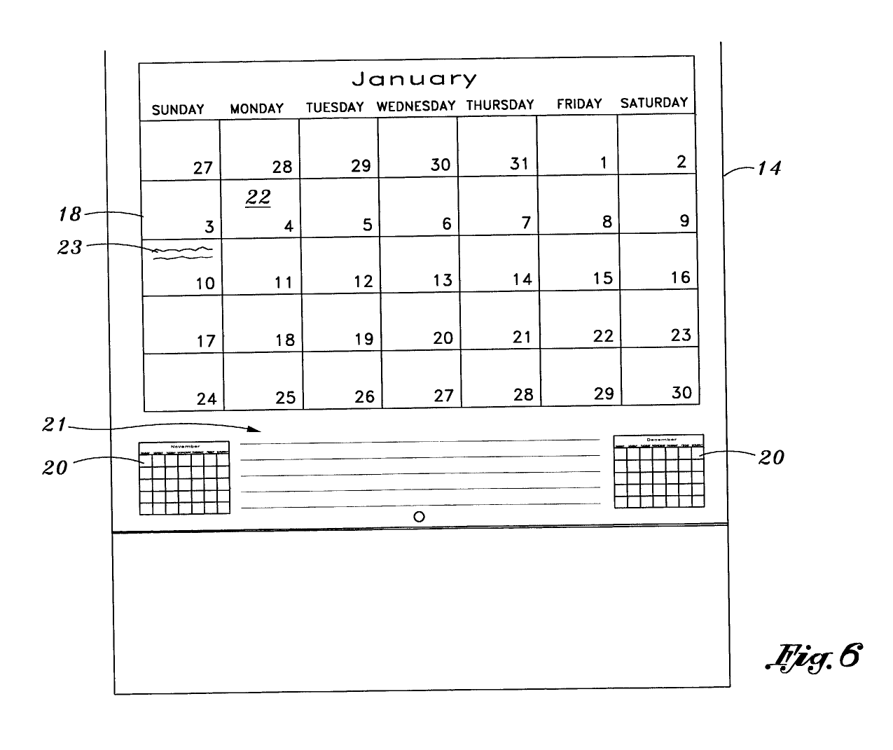

As shown in FIG. 5, the calendar 10 may be in an open position. In the open position, the papers 14 may be positioned to provide a single view 15 to a user. What is meant by a “single view” is that which is viewable on the calendar 10 without having to turn one paper 14 to view another paper 14. In this embodiment, it can be seen in FIG. 5 that the single view 15 is made of two papers 14. However, it is contemplated that other number of papers 14, fewer or greater than two, may comprise the single view 15.

In any event, the single view 15 may include a first sub-view 16 and a second sub-view 17, both of which comprise sections or parts of the entire single view 15. In the embodiment of FIG. 5, the first sub-view 16 may include a current time period section 18 and an adjacent prior time period section 20. For this embodiment, the prior time period section 20 is positioned above the current time period section 18, when viewed from FIG. 5. Nevertheless, other relative arrangements are contemplated, such as a reverse position whereby the prior time period section 20 is positioned below the current time period section. It is further contemplated that the first sub-view 16 may include one or a combination of the current time period section 18, the adjacent prior time period section 20, and a subsequent time period section 19 described below.

In the preferred embodiment shown in FIG. 5, the current time period 18 may represent the then actual period of the year or the period of time that is of primary interest to a user of the calendar 10. At the same time, the prior time period section 20 may represent a period of time prior to that covered in the current time period 18. As an example, the current time period 18 may be the single month of January 2001. Thereby, the prior time period section 20 may be the two months of November and December 2000. Still, it should be understood that current time period section 18 may cover a period of time more or less than one month, and the prior time period section 20 may cover a period of time more or less than two months.

While the dimensions may be varied, a preferred embodiment of the current time period section 18 is such that it is about 7 inches high×11 inches wide. With such current time period section 18, each prior time period section 20 is about 1½ inches high×1½ inches wide.

In the embodiment of FIG. 5, the second sub-view 17 includes a subsequent time period section 19 that covers a period time subsequent to that covered in the current time period section 18. Yet, it can be appreciated that the subsequent time period section 19 may be placed in the first sub-view 16 while the current and prior time period sections 18, 20 are placed in the second sub-view 17. Furthermore, the present invention contemplates that the second sub-view 17 may include one or a combination of the current time period section 18, the adjacent prior time period section 20, and the subsequent time period section 19.

For the embodiment shown in FIG. 5, the subsequent time period section 19 covers the two months of February and March 2001. Yet, as above, the present invention contemplates that a period of less than or more than two months may be contained in the subsequent time period section 19. Further, a preferred dimension for a subsequent time period section 19 is about 9 inches high×5 inches wide.

Based on the foregoing, it can be understood that the single view 15 in the embodiment of FIG. 5 provides a user with a view of a period of five months, including the current month, two months prior to the current month, and two months subsequent to the current month. Of course, the number of months covered in the single view 15 can vary depending upon the number of days, weeks, or months covered by each of the current, subsequent and prior time period sections 18-20.

In an alternative embodiment, the single view 15 may comprise an image, such as a photograph or an abstraction, in either the first or second sub-views 16, 17. Although not necessary, such an image can add to the aesthetics of the calendar 10, thereby increasing the ease with which the calendar 10 may be used. If, for example, an image is contained in the second sub-view 17, the first sub-view may contain one or a combination of the current time period section 18, the adjacent prior time period section 20, and the subsequent time period section 19. Even though, as an example, the second sub-view 17 contains an image, the second sub-view 17 may additionally contain one or a combination of the current time period section 18, the adjacent prior time period section 20, and the subsequent time period section 19.

Irrespective of the number of days, weeks or months covered in each of the time period sections 18-20, each section comprises a plurality of writing areas 22 that correspond in number to the number of days covered. As an example, in FIG. 5, each month contained in any one section 18-20 includes thirty-five writing areas 22. Thus, for January 2001 in the current time period section 18, there are thirty writing areas 22 that cover the 30 days in January 2001 and five writing areas 22 that cover the five days of December 2000. Likewise, for the months of February and March 2001 in the subsequent time period section 19, there are thirty writing areas 22 for each month. For the months of November and December 2000 in the prior time period section 20, there are thirty-five writing areas 22 for each month.

It can be seen in FIG. 5 that the writing areas 22 of the current time period section 18 may be larger that those in the subsequent time period section 19. Further, the writing areas 22 in the subsequent time period section 19 may be larger than those in the prior time period section 20. Such relative sizes may be desirable, for example, when a user may be expected to create more notes in the writing areas 22 of the current time period section 18, fewer notes in the subsequent time period section 19, and even fewer notes in the prior time period section 20. However, it is contemplated that other relative sizes for the writing areas 22 can be employed, including a circumstance where all of the writing areas 22 are of equal size.

Preferably, the writing areas 22 in the time period sections 18-20 may be used to create and retain first or time sensitive notes 23, as shown in an alternative embodiment of FIG. 6. A single time sensitive note 23 may correlate to a specific date(s) in one or more of the sections 18-20. The time sensitive note 23 may be created on a separate element, such as a Post-It-Note by 3M, and retained on the calendar by being adhered to a writing area 22 of the recording element 14. Alternatively, the writing area 22 may be made of a material such as paper such that a user may employ a writing instrument such as a pen to create the note 23 directly onto the writing area 22 for retention.

Optionally, a non-time sensitive section 21 may comprise a part of the calendar 10. The non-time sensitive section 21 may provide a means for creating and retaining second or non-time sensitive notes 24, as in FIG. 6. In one example, the non-time sensitive section 21 may be adjacent to the first and second covers 11, 12. More specifically, the non-sensitive section 21 may be affixed to the back cover 12 and positioned below the current time period section 18, when viewed from FIG. 6. In such instance, the non-time sensitive section 21 may be made of a cork material affixed to the back cover 12 and adjacent the recording element 14 having the current time period section 18. Optionally, the non-time sensitive section 21 may have a cut-out portion (not shown) that allows a user to place and store push pins, for example. Such a non-time sensitive section 21 would allow a user to create a note 24 on a separate element such as a piece of paper and then retain the note 24 by pinning the note 24 to the cork material. In this example, the note 24 may not correlate to a specific date and is therefore not time sensitive.

Alternatively, the non-time sensitive section 21 may comprise a part of the recording element 14 itself (FIG. 6). In such instance, the non-time sensitive section 21 may comprise a writing area 22 having a plurality of lines for creating and retaining notes 24, such as by the use of a writing instrument. This type of non-sensitive section 21 may be supplemental to and/or as a substitute for the cork type of non-time sensitive section 21 described above.

A support 25 (not shown) may be affixed to the back cover 12 to allow the calendar 10 to be hung from a wall and thereby display the single view 15. As an example, the support 25 may be in the form of Velcro strips.

As can be appreciated by those skilled in the art, the present invention provides an apparatus that allows for date sensitive note creation and retention. The apparatus of the present invention provides supplemental means for note creation and retention that may not be date sensitive. A note creating and retention apparatus in the form of a calendar is provided by the present invention such that a single view includes access to notes that span more than 30 days, including up to about 5 months. The note creating and retention calendar may hang from a wall, for example, while displaying in a single view up to 5 months of notes and providing access to days outside of such 5 months. The present calendar is simple in design yet provides note creating and retaining means.

It should be understood, of course, that the foregoing relates to preferred embodiments of the invention and that modifications may be made without departing from the spirit and scope of the invention as set forth in the following claims.

What is claimed is:

1. An apparatus for note creation and retention, comprising:
a first cover;
a second cover interfacing said first cover;
a recording element disposed between said first and second covers;
said recording element being positionable in a single view to a user; and
said single view having an image and at least two sections selected from the group consisting of a current time period section, a prior time period section, and a subsequent time period section, with each section for creating and retaining first notes.

2. The apparatus of claim 1, further comprising a non-time sensitive section adjacent said recording element, said non-time sensitive section for creating and retaining second notes.

3. The apparatus of claim 1, further comprising a support affixed to one of said first and second covers.

4. The apparatus of claim 1, further comprising a binding that binds together said first and second covers.

5. The apparatus of claim 1, wherein said recording element is made of a paper material.

6. The apparatus of claim 1, wherein said first notes are created by a writing instrument.

7. An apparatus for note creation and retention, comprising:
a first cover;
a second cover interfacing said first cover;
a plurality of recording elements disposed between said first and second covers;
said recording elements being positionable in at least one single view to a user;
said single view having an image and at least two sections selected from the group consisting of a current time period section, a prior time period section, and a subsequent time period section, with each section for creating and retaining first notes; and
a non-time sensitive section adjacent at least one of said first and second covers for creating and retaining second notes.

8. The apparatus of claim 7, wherein said current time period section includes at least one month.

9. The apparatus of claim 7, wherein said prior time period section includes at least two months.

10. The apparatus of claim 7, wherein said subsequent time period section includes at least two months.

11. The apparatus of claim 7, wherein said recording elements are made of a material onto which another element containing said first notes can be adhered.

12. The apparatus of claim 7, wherein said recording elements are made of a material directly onto which said first notes may be created by a writing instrument.

13. The apparatus of claim 7, wherein said non-time sensitive section is made of a material onto which another element containing said second notes can be affixed.

14. The apparatus of claim 7, wherein said non-sensitive time section is made of said recording elements.

15. The apparatus of claim 7, wherein said non-sensitive time section is adjacent said recording elements.

16. A note creating and retention calendar, comprising:
a first cover;
a second cover interfacing said first cover;
a plurality of recording elements disposed between said first and second covers;
said recording elements being positionable in a plurality of single views to a user;
at least one of said single views having a current time period section of at least one month, a prior time period section of at least two months, and a subsequent time period section of at least two months, said sections for creating and retaining first notes; and
a non-time sensitive section adjacent said at least one of said single views for creating and retaining second notes.

17. The calendar of claim 16, wherein said at least one of said single views further comprises a first sub-view adjacent a second sub-view.

18. The calendar of claim 17, wherein at least one of said first sub-view and second sub-view comprises an image.

19. The calendar of claim 17, wherein said first sub-view comprises said current and prior time sections.

20. The calendar of claim 19, wherein said second sub-view comprises said subsequent time period section.

21. The calendar of claim 20, wherein said non-sensitive time section is adjacent said first sub-view.

22. The calendar of claim 16, wherein said current time period, prior time period and subsequent time period sections comprise a plurality of note writing areas.

23. The calendar of claim 16, wherein said non-sensitive time section is made of a cork material.
